(19) United States
(12) Patent Application Publication
(10) Pub. No.: US 2026/0156675 A1
(43) Pub. Date: Jun. 4, 2026

(54) MANAGING TRAFFIC TO BE TRANSMITTED DURING COORDINATED TIME DIVISION MULTIPLE ACCESS (C-TDMA)

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/386,115

(22) Filed: Nov. 11, 2025

Related U.S. Application Data
(60) Provisional application No. 63/727,156, filed on Dec. 2, 2024.

(51) Int. Cl. H04W 74/0808; H04W 88/08

(52) U.S. Cl. CPC H04W 74/0808; H04W 88/08

(57) ABSTRACT

Disclosed herein is a method performed by a wireless device to poll candidate shared APs regarding participation in coordinated time division multiple access (c-TDMA). The method includes transmitting a first control frame to poll candidate shared APs regarding participation in the c-TDMA, wherein the first control frame includes an indication of a primary traffic priority level of traffic to be transmitted during the c-TDMA, receiving, from one or more candidate shared APs as a response to the first control frame, one or more first response frames indicating that the one or more candidate shared APs are interested in participating in the c-TDMA, and selecting one of the one or more candidate shared APs that responded to the first control frame to participate in the c-TDMA based on information included in the one or more first response frames received from the one or more candidate shared APs.

### CROSS-REFERENCE TO RELATED APPLICATION

This application claims the benefit of U.S. Provisional Application No. 63/727,156, filed Dec. 2, 2024, titled “Approach for managing low-latency and non low-latency traffic in C-TDMA”, which is hereby incorporated by reference.

### TECHNICAL FIELD

The present disclosure generally relates to wireless communications, and more specifically, relates to managing traffic to be transmitted during coordinated time division multiple access (c-TDMA).

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

Coordinated time division multiple access (C-TDMA or c-TDMA) is a multi-AP coordination scheme that allows an access point (AP) to share its transmission opportunity (TXOP) with other AP(s). For example, with c-TDMA, a first AP that owns a TXOP may share a portion of the TXOP with a second AP. The second AP may then transmit and receive in its basic service set (BSS) during the allocated portion of the TXOP. Stated differently, the first AP may allocate a portion of the TXOP to the second AP to allow the second AP to transmit and receive with its associated non-AP stations (STAs) during the allocated portion of the TXOP even though the second AP is not the original TXOP owner. If the second AP finishes transmission and reception before its allocated portion of the TXOP expires, the second AP may be allowed to return the TXOP to the first AP so that the first AP can resume the TXOP. In this TXOP sharing scenario, the first AP may be referred to as the sharing AP and the second AP may be referred to as the shared AP.

The sharing AP may indicate to the shared AP in advance whether the shared AP is allowed to return the TXOP. The shared AP may decide to return the TXOP if the shared AP will not use all of its allocated portion of the TXOP (e.g., if the shared AP finishes transmission and/or reception early, before its allocated portion of the TXOP expires). If the sharing AP indicates that TXOP return is allowed, the shared AP may return the TXOP to the sharing AP before the shared AP's allocated portion of the TXOP expires. If TXOP return is not allowed, the shared AP may use its allocated portion of the TXOP until it expires or provide a fair contention-based state (i.e., contention-free) that allows other STAs to access the channel for transmission.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a coordinated time division multiple access (c-TDMA) scenario where transmission opportunity (TXOP) return is not allowed and the shared access point (AP) uses all of its allocated portion of the TXOP, according to some embodiments.

FIG. 11 is a diagram showing a c-TDMA scenario where TXOP return is allowed and the sharing AP resumes the TXOP after receiving a TXOP return frame from the shared AP, according to some embodiments.

FIG. 12 is a diagram showing a c-TDMA scenario where TXOP return is allowed and the sharing AP shares its TXOP with multiple APs in succession, according to some embodiments.

FIG. 13 is a diagram showing a duration/ID field included in the multi-user request-to-send TXOP sharing (MU-RTS TXS) frame being set to the sum of a clear-to-send (CTS) frame transmission duration and one short interframe space (SIFS) interval duration, according to some embodiments.

FIG. 14 is a diagram showing a polling phase and in-basic service set (BSS) frame exchange being performed before a TXOP allocation phase, according to some embodiments.

FIG. 15 is a diagram showing a frame exchange sequence for c-TDMA, according to some embodiments.

FIG. 16 is a diagram showing how a shared AP can use the time remaining in its allocated portion of the TXOP in a c-TDMA scenario where TXOP return is allowed, according to some embodiments.

FIG. 17 is a diagram showing how a shared AP can use the time remaining in its allocated portion of the TXOP in a c-TDMA scenario where TXOP return is not allowed, according to some embodiments.

FIG. 18 is a flow diagram of a method for polling candidate shared APs regarding participation in c-TDMA, according to some embodiments.

FIG. 19 is a flow diagram of a method for participating in c-TDMA, according to some embodiments.

### DETAILED DESCRIPTION

The present disclosure generally relates to wireless communications, and more specifically, relates to managing traffic to be transmitted during coordinated time division multiple access (c-TDMA).

Performing c-TDMA may involve three phases: a polling phase, a transmission opportunity (TXOP) allocation phase, and a return phase. During the polling phase, a sharing access point (AP) may poll candidate shared APs regarding their interest in participating in the c-TDMA. For example, during the polling phase, the sharing AP may transmit an initial control frame (ICF) to poll candidate sharing APs regarding their interest in participating in the c-TDMA. Candidate shared APs that receive the initial control frame from the sharing AP may transmit an initial control response frame (ICR) to the sharing AP indicating their interest (or disinterest) in participating in the c-TDMA. The sharing AP may select one or more of the candidate shared APs that showed interest in participating in the c-TDMA to participate in the c-TDMA. During the TXOP allocation phase, the sharing AP may share a portion(s) of its TXOP with the one or more candidate shared APs that were selected during the polling phase. The selected candidate shared APs may then use their respective allocated portions of the TXOP to transmit and receive traffic with their associated non-AP stations (STAs). During the return phase, a candidate shared AP that has been allocated a portion of the sharing AP's TXOP may return the TXOP back to the sharing AP if the candidate shared AP finishes transmission and/or reception before its allocated portion of the TXOP has expired.

For the sharing AP to appropriately select the candidate shared AP(s) that should participate in the c-TDMA (e.g., select candidate shared AP(s) in a manner that satisfies quality of service (QoS) requirements), the sharing AP should know the current situations of the candidate shared APs in terms of the traffic that the candidate shared APs have in their queues to transmit (or any other traffic that the candidate shared APs might want to transmit in the future). A polling mechanism is described herein that allows the sharing AP to obtain information that the sharing AP can use to select the candidate shared AP(s) that should participate in the c-TDMA.

According to some embodiments, the sharing AP transmits a first control frame (e.g., an initial control frame) to poll candidate shared APs regarding participation in the c-TDMA, wherein the first control frame includes an indication of a primary traffic priority level of traffic to be transmitted during the c-TDMA. A candidate shared AP that receives the first control frame may determine whether it possesses traffic to transmit having the primary traffic priority level indicated in the first control frame or a higher traffic priority level. If the candidate shared AP possesses traffic having the primary traffic priority level indicated in the first control frame or the higher traffic priority level, the candidate shared AP may transmit a first response frame (e.g., initial control response frame) to the sharing AP indicating that the candidate shared AP is interested in participating in the c-TDMA. If the candidate shared AP does not possess traffic having the primary traffic priority level indicated in the first control response frame or a higher priority level, but the candidate shared AP possesses other traffic having a lower priority traffic level than the primary traffic priority level indicated in the first control frame, the candidate shared AP may transmit a first response frame indicating the highest traffic priority level of traffic that it possesses. Otherwise, if the candidate shared AP does not have any traffic to transmit, the candidate shared AP may not respond to the first control frame or transmit a first response frame indicating that it is not interested in participating in the c-TDMA. The sharing AP may receive response frames from multiple candidate shared APs. The sharing AP may select one of the candidate shared APs that responded to the first control frame to participate in the c-TDMA based on information included in the response frames received from the candidate shared APs. The sharing AP may then transmit a second control frame (e.g., a multi-user request-to-send TXOP sharing (MU-RTS TXS) frame) to the selected candidate shared AP to share a portion of the sharing AP's TXOP with the selected candidate shared AP. Responsive to receiving the second control frame from the sharing AP, the selected candidate shared AP may transmit a second response frame (e.g., a clear-to-send (CTS) frame) to the sharing AP and transmit traffic in its own BSS during the portion of the TXOP allocated to the selected candidate shared AP. For example, if the selected candidate shared AP possesses traffic having the primary traffic priority level indicated in the first control response frame or a higher traffic priority level, the selected candidate shared AP may start transmitting that traffic during the portion of the TXOP allocated to the selected candidate shared AP.

The polling mechanism described herein allows the sharing AP to obtain information that the sharing AP can use to make appropriate decisions regarding which candidate shared AP(s) should participate in the c-TDMA. For example, the sharing AP may prioritize candidate shared AP(s) that possess low-latency (LL) traffic or traffic associated with a particular access category (AC) when selecting the final shared AP.

In some cases, a shared AP may finish transmission and/or reception early, before its allocated portion of the TXOP expires. In an embodiment, if a shared AP finishes transmitting and receiving low-latency traffic or traffic associated with a particular access category (AC) before the portion of the TXOP allocated to the shared AP expires, the shared AP may start transmitting traffic having a lower traffic priority level. For example, if the shared AP finishes transmission and reception of low-latency traffic early and there is still time remaining in the portion of the TXOP allocated to the shared AP, the shared AP may be allowed to transmit and/or receive non-low-latency traffic or traffic associated with other AC(s).

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

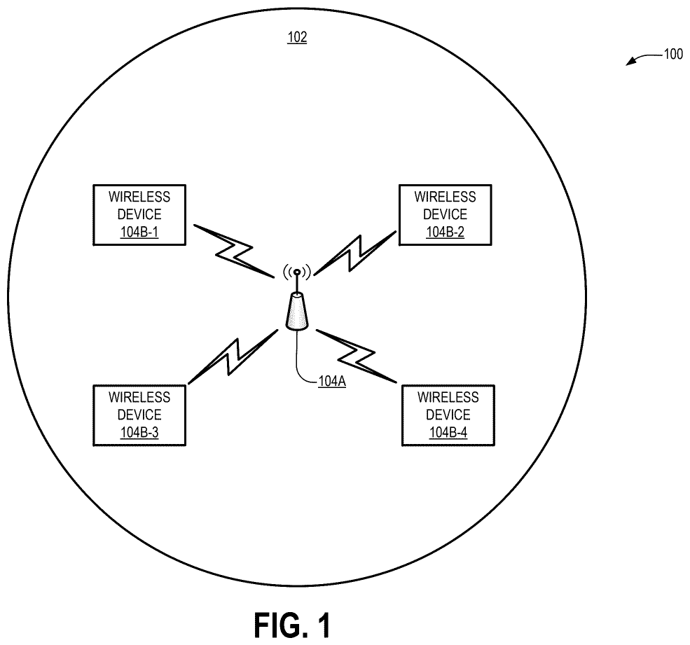

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

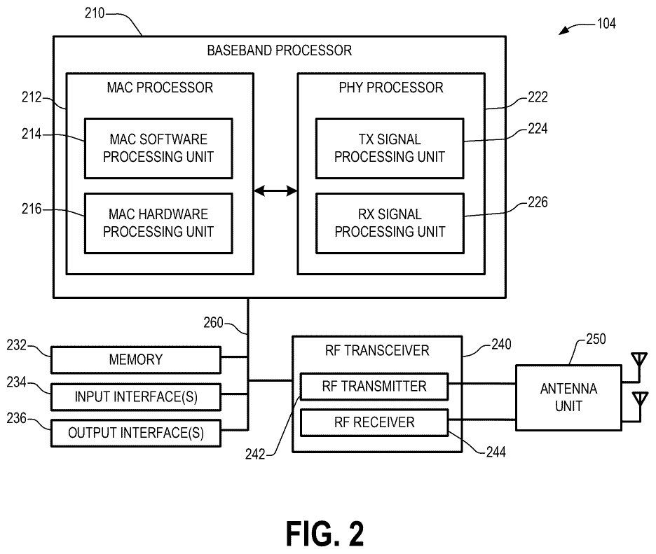

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

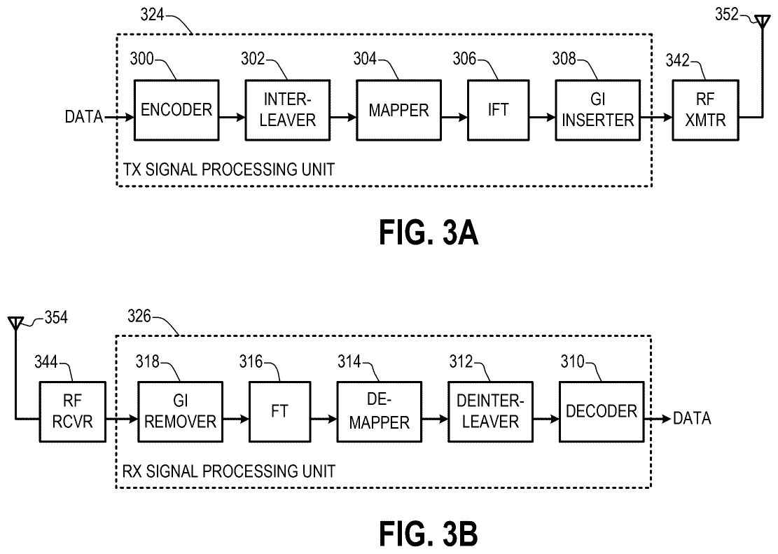

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

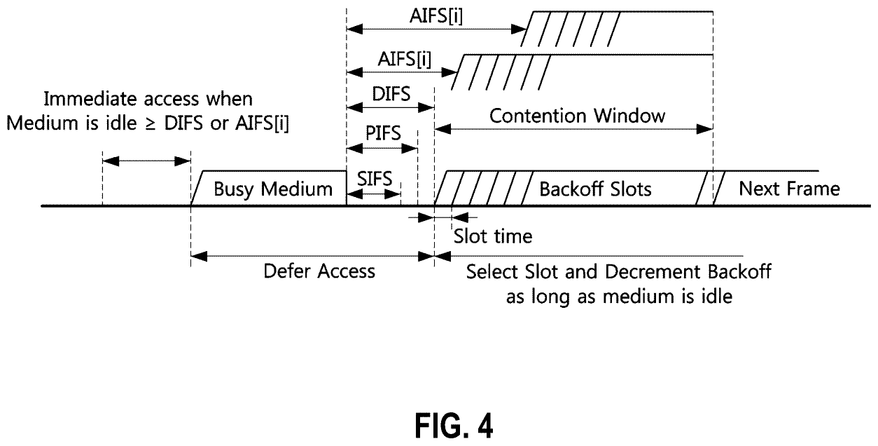

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

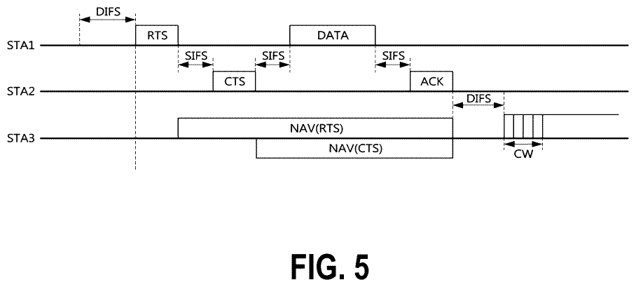

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

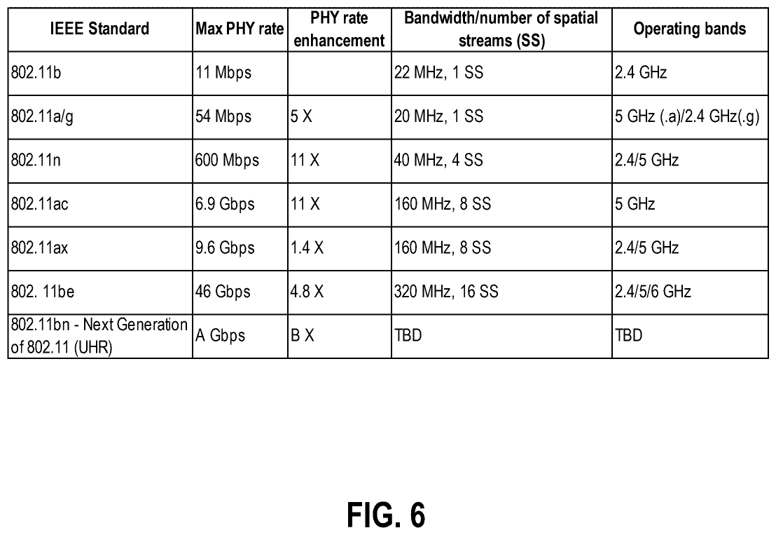

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

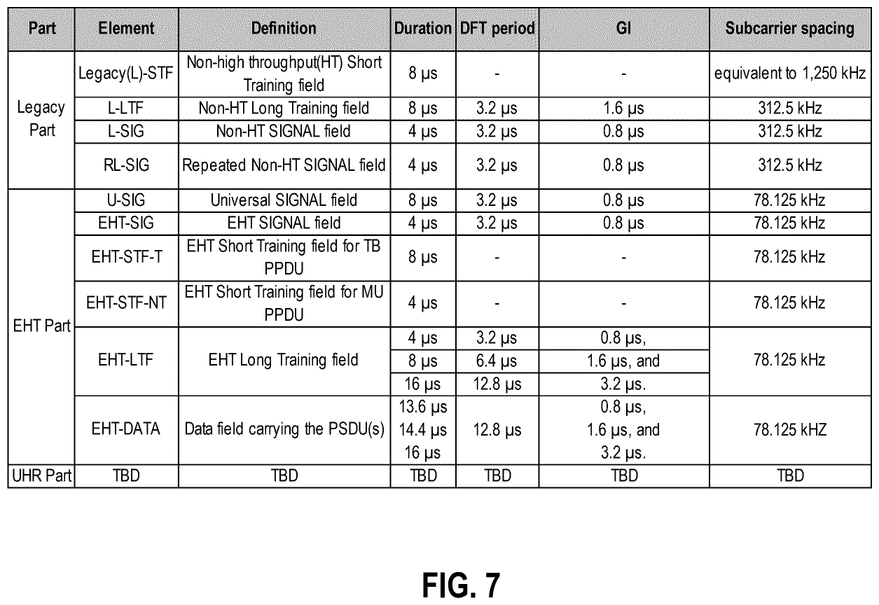

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

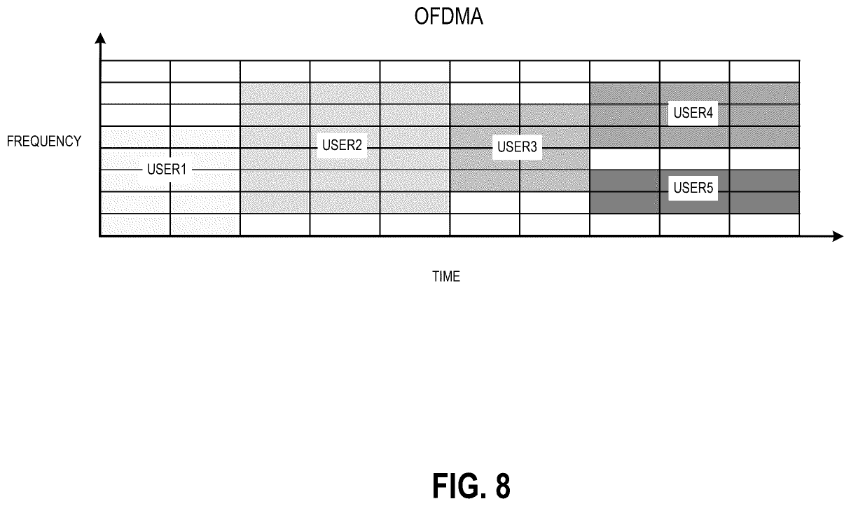

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

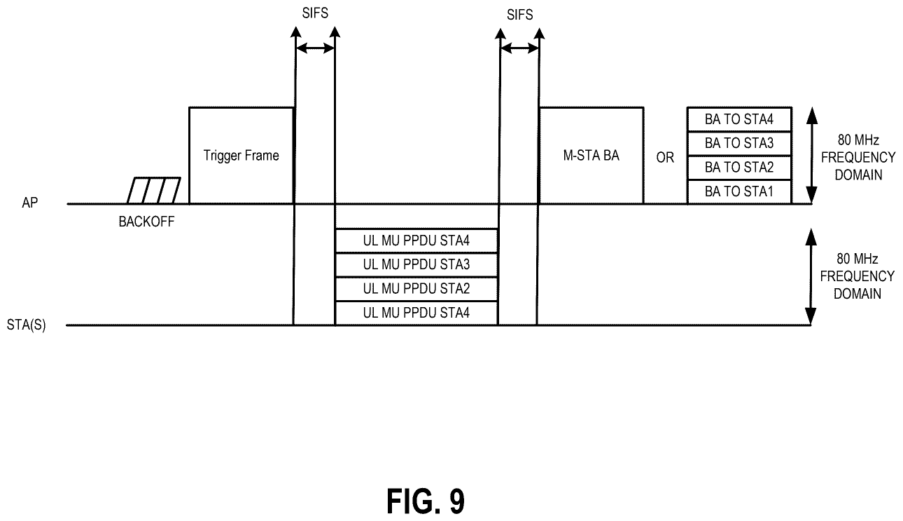

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

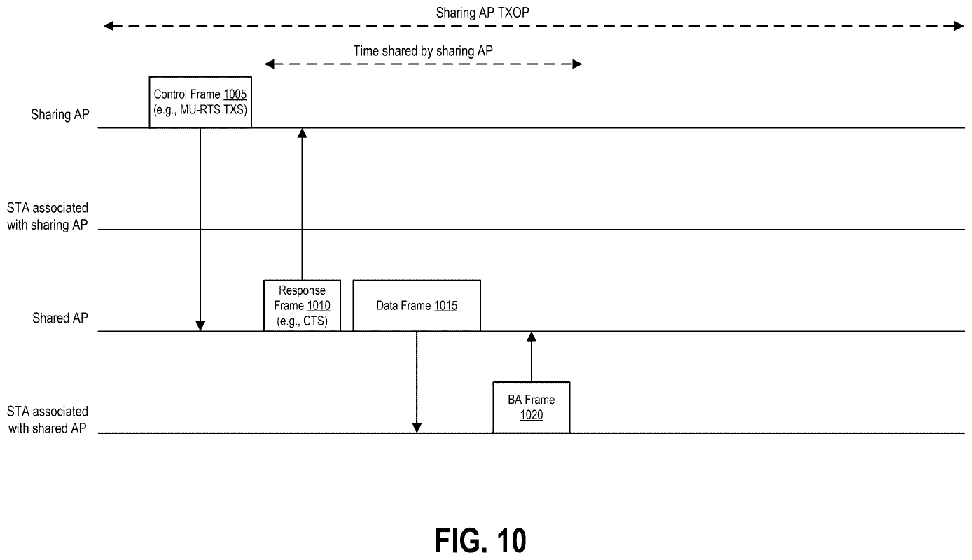

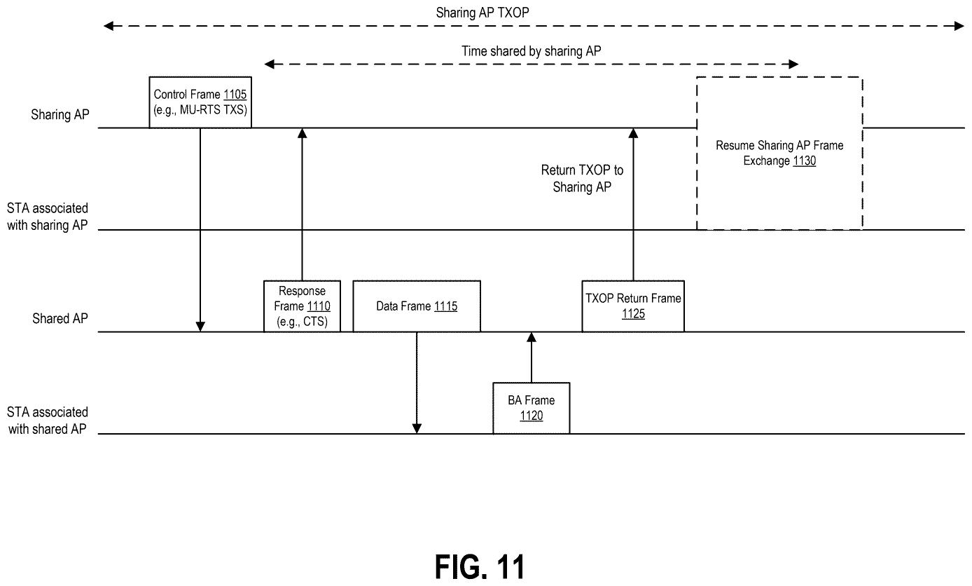

In a c-TDMA scenario, TXOP return may be allowed or not allowed. FIG. 10 shows a c-TDMA scenario where TXOP return is not allowed and FIG. 11 shows a c-TDMA scenario where TXOP return is allowed.

FIG. 10 is a diagram showing a c-TDMA scenario where TXOP return is not allowed and the shared AP uses all of its allocated portion of the TXOP, according to some embodiments.

As shown in the diagram, the sharing AP may transmit control frame 1005 to the shared AP to indicate to the shared AP that the sharing AP is allocating a portion of the sharing AP's TXOP to the shared AP. In an embodiment, control frame 1005 is a MU-RTS TXS frame. Responsive to receiving control frame 1005, the shared AP may transmit response frame 1010 to the sharing AP. In an embodiment, response frame 1010 is a CTS frame. During the portion of the sharing AP's TXOP allocated to the shared AP (depicted as “Time shared by sharing AP” in the diagram), the shared AP may transmit data frame 1015 to a STA that is associated with the shared AP. If the STA successfully receives data frame 1015, the STA may transmit block acknowledgement (BA) frame 1020 to the shared AP. The sharing AP may resume its TXOP (e.g., resume transmission and reception with its associated non-AP STAs) after the portion of the TXOP allocated to the shared AP expires.

FIG. 11 is a diagram showing a c-TDMA scenario where TXOP return is allowed and the sharing AP resumes the TXOP after receiving a TXOP return frame from the shared AP, according to some embodiments.

The diagram illustrates a c-TDMA scenario where the sharing AP allocates a portion of its TXOP to the shared AP and allows TXOP return. The shared AP completes its transmission and reception before the allocated portion of the TXOP expires and the shared AP returns the TXOP to the sharing AP, which allows the sharing AP to resume the TXOP and continue transmission and reception with its associated non-AP STAs.

As shown in the diagram, the sharing AP may transmit control frame 1105 (e.g., MU-RTS TXS frame) to the shared AP to indicate to the shared AP that the sharing AP is allocating a portion of the sharing AP's TXOP to the shared AP. Responsive to receiving control frame 1105, the shared AP may transmit response frame 1110 (e.g., CTS frame) to the sharing AP. During the portion of the sharing AP's TXOP allocated to the shared AP (depicted as “Time shared by sharing AP” in the diagram), the shared AP may transmit data frame 1115 to a STA that is associated with the shared AP. If the STA successfully receives data frame 1115, the STA may transmit BA frame 1120 to the shared AP. If the shared AP finishes transmission reception in its BSS before its allocated portion of the TXOP expires, the shared AP may transmit TXOP return frame 1125 to the sharing AP to return the TXOP to the sharing AP. Upon receiving TXOP return frame 1125, the sharing AP may resume the TXOP. For example, the sharing AP may perform frame exchange 1130 in its own BSS with its associated non-AP STAs.

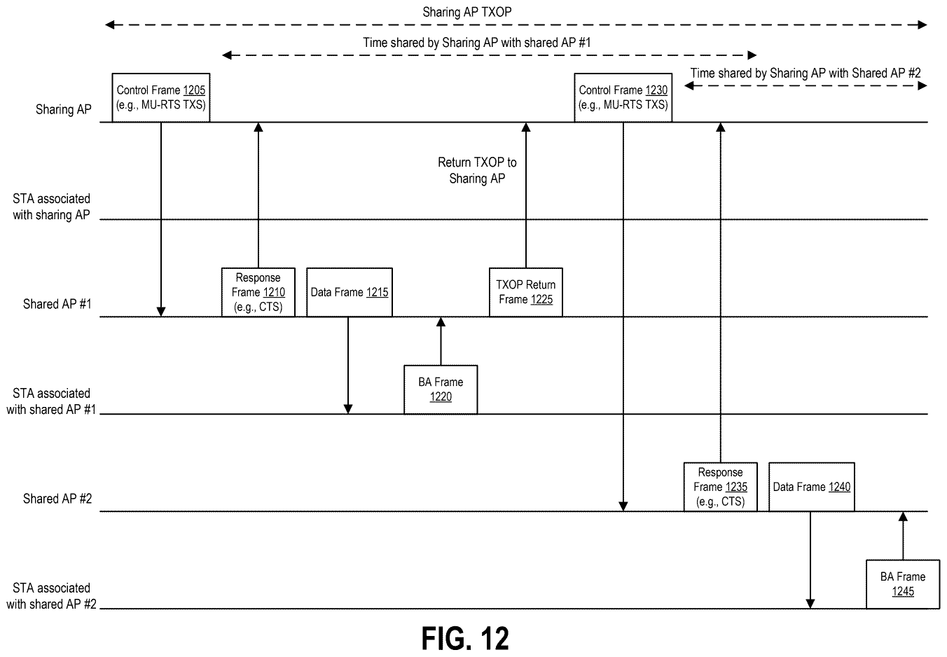

FIG. 12 is a diagram showing a c-TDMA scenario where TXOP return is allowed and the sharing AP shares its TXOP with multiple APs in succession, according to some embodiments.

The diagram illustrates a c-TDMA scenario where the sharing AP allocates a portion of its TXOP to the shared AP and requests TXOP return. The shared AP completes its transmission and reception before its allocated portion of the TXOP expires and the shared AP returns the TXOP to the sharing AP, which allows the sharing AP to resume the TXOP. After resuming the TXOP, the sharing AP allocates another portion of its TXOP to another shared AP.

As shown in the diagram, the sharing AP may transmit control frame 1205 (e.g., MU-RTS TXS frame) to shared AP #1 to indicate to shared AP #1 that the sharing AP is allocating a portion of the sharing AP's TXOP to shared AP #1. Responsive to receiving control frame 1205, shared AP #1 may transmit response frame 1210 (e.g., CTS frame) to the sharing AP. During the portion of the sharing AP's TXOP allocated to shared AP #1 (depicted as “Time shared by sharing AP with shared AP #1” in the diagram), shared AP #1 may transmit data frame 1215 to a STA that is associated with shared AP #1. If the STA successfully receives data frame 1215, the STA may transmit BA frame 1220 to shared AP #1. If shared AP #1 finishes transmission and reception in its BSS before the allocated portion of the TXOP expires, shared AP #1 may transmit TXOP return frame 1225 to the sharing AP to return the TXOP to the sharing AP. Upon receiving TXOP return frame 1225, the sharing AP may resume the TXOP. The sharing AP may then transmit control frame 1230 (e.g., MU-RTS TXS frame) to shared AP #2 to indicate to shared AP #2 that the sharing AP is allocating a portion of the sharing AP's TXOP to shared AP #2. Responsive to receiving control frame 1230, shared AP #2 may transmit response frame 1235 (e.g., CTS frame) to the sharing AP. During the portion of the sharing AP's TXOP allocated to shared AP #2 (depicted as “Time shared by sharing AP with shared AP #2” in the diagram), shared AP #2 may transmit data frame 1240 to a STA that is associated with shared AP #2. If the STA successfully receives data frame 1240, the STA may transmit BA frame 1245 to shared AP #2.

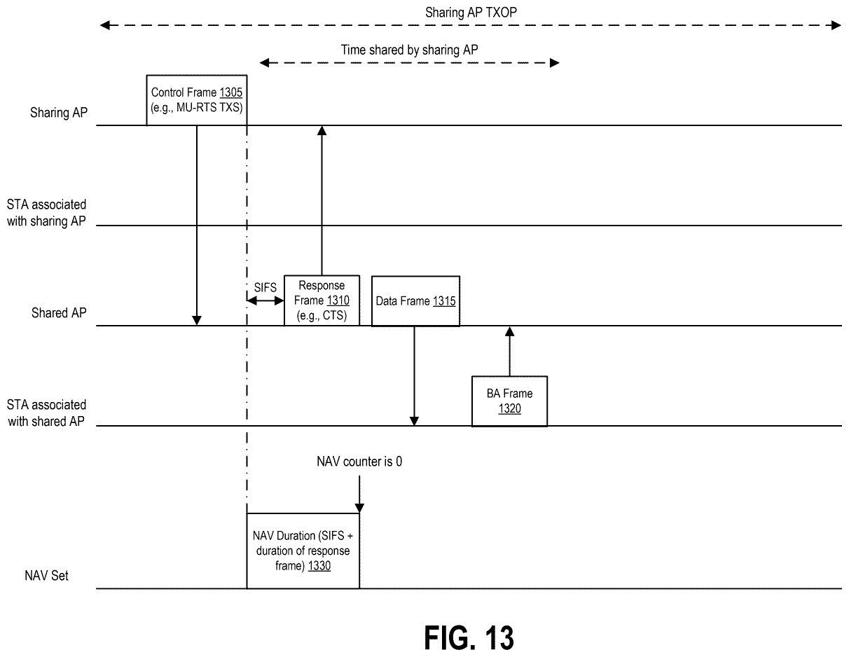

FIG. 13 is a diagram showing a duration/ID field included in the MU-RTS TXS frame being set to the sum of a CTS frame transmission duration and one SIFS interval duration, according to some embodiments.

The diagram illustrates the NAV duration in a c-TDMA scenario where the sharing AP allocates a portion of its TXOP to the shared AP using a control frame exchange (e.g., MU-RTS TXS frame and CTS frame exchange).

As shown in the diagram, the sharing AP may transmit control frame 1305 (e.g., MU-RTS TXS frame) to the shared AP to indicate to the shared AP that the sharing AP is allocating a portion of the sharing AP's TXOP to the shared AP. Responsive to receiving control frame 1305, the shared AP may transmit response frame 1310 (e.g., CTS frame) to the sharing AP after a short interframe space (SIFS) interval after receiving control frame 1305. During the portion of the sharing AP's TXOP allocated to the shared AP (depicted as “Time shared by sharing AP” in the diagram), the shared AP may transmit data frame 1315 to a STA that is associated with the shared AP. If the STA successfully receives data frame 1315, the STA may transmit BA frame 1320 to the shared AP.

Control frame 1305 may set a NAV duration 1330 that corresponds to the sum of the transmission duration of response frame 1310 and a SIFS interval duration. For example, if control frame 1305 is a MU-RTS TXS frame and response frame 1310 is a CTS frame, the duration/ID field included in the MU-RTS TXS frame may be set to indicate the duration required to transmit the CTS frame plus the duration of one SIFS interval.

In the scenarios shown in FIGS. 10-13, the sharing AP is depicted as transmitting the MU-RTS TXS frame in the middle of its TXOP and not at the beginning of its TXOP. The reason for this is that, prior to transmitting the MU-RTS TXS frame to share its TXOP, the sharing AP may perform a process to select the AP(s) that are to be allocated a portion of the sharing AP's TXOP. Also, prior to transmitting the MU-RTS TXS frame, the sharing AP may perform frame exchanges with non-AP STAs associated with the sharing AP.

During a polling phase (prior to allocating a portion of its TXOP to a shared AP), the sharing AP may transmit an initial control frame to candidate shared AP(s). The candidate shared AP(s) may be candidate(s) to be the final shared AP(s). The initial control frame may serve the role of polling the candidate AP(s) regarding their interest in participating in the c-TDMA. For example, the initial control frame and the corresponding response frame (e.g., an initial control response frame (ICR)) may include information regarding the quality of service (QoS) characteristics of the traffic to be processed during the c-TDMA such as AC, traffic identifier (TID), and stream classification service identifier (SCSID) for the traffic. Through the initial control frame and initial control response frame exchange, the sharing AP may be able to obtain information that can help it decide which candidate shared AP(s) should be selected as the shared AP(s) for TXOP sharing. If multiple candidate shared APs are selected to be the final shared APs (e.g., as shown in FIG. 12), the sharing AP may sequentially share portions of its TXOP with the selected candidate shared APs.

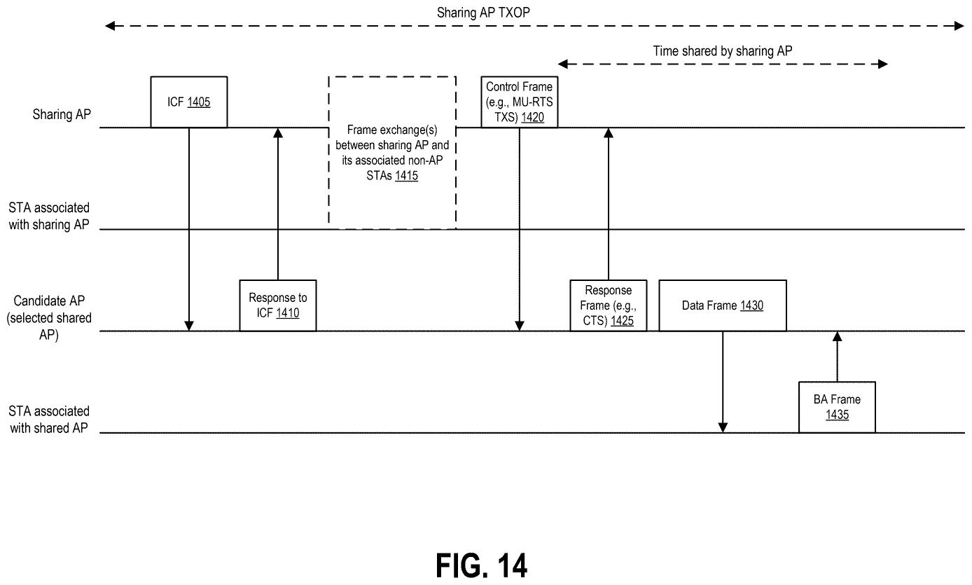

FIG. 14 is a diagram showing a polling phase and in-BSS frame exchange being performed before a TXOP allocation phase, according to some embodiments.

The example shown in the diagram is an example where the sharing AP polls a single candidate shared AP regarding its interest in participating in the c-TDMA and selects the single candidate shared AP to be the final shared AP to participate in the c-TDMA.

As shown in the diagram, the sharing AP may transmit an initial control frame 1405 to the candidate shared AP. The candidate shared AP may transmit a response frame 1410 to the sharing AP as a response to initial control frame 1405. The sharing AP may then select the candidate shared AP to participate in the c-TDMA (e.g., because the candidate shared AP's response may indicate that the it is interested in participating in the c-TDMA).

However, before allocating a portion of its TXOP to the selected candidate shared AP, the sharing AP may use the TXOP to perform frame exchange 1415 with its in-BSS non-AP STAs (STAs that are associated with the sharing AP).

After performing frame exchange 1415, the sharing AP may transmit control frame 1420 to the candidate shared AP to share a portion of its TXOP with the candidate shared AP. In an embodiment, control frame 1420 is a MU-RTS TXS frame. Responsive to receiving control frame 1420, the candidate shared AP may transmit response frame 1425 to the sharing AP. In an embodiment, response frame 1425 is a CTS frame. The candidate shared AP becomes the final shared AP. During the portion of the TXOP allocated to the candidate shared AP (depicted as “Time shared by sharing AP” in the diagram), the candidate shared AP may transmit data frame 1430 to a STA that is associated with the candidate shared AP. Responsive to receiving data frame 1430, the STA associated with the candidate shared AP may transmit BA frame 1435 to the candidate shared AP.

As shown in this example, the sharing AP may use its TXOP (for transmission and reception with its associated non-AP STAs) before transmitting control frame 1420 to the shared AP (i.e., before sharing a portion of its TXOP with a shared AP).

As previously mentioned, during a c-TDMA process, the sharing AP may decide which candidate shared AP(s) to designate as the final shared AP(s). Also, in some cases, the sharing AP may determine that using the TXOP for transmission in its own BSS is more efficient/important than performing c-TDMA.

The sharing AP's decision of whether to perform c-TDMA and with which APs to perform c-TDMA with may be made based on information obtained through a frame exchange (e.g., ICF/ICR frame exchange) with candidate shared AP(s) during the polling phase. Stated differently, based on information obtained during the polling phase (e.g., through an ICF/ICR frame exchange), the sharing AP may decide whether to share a portion of its TXOP with other AP(s) or use the TXOP for transmission and reception in its own BSS. Thus, the sharing AP is not obligated to perform c-TDMA. For example, if there are no candidate shared AP(s) with sufficiently urgent traffic to transmit, the sharing AP may decide not to perform c-TDMA.

The decision of which candidate shared AP(s) to designate as the final shared AP(s) or whether to skip c-TDMA altogether may be made based on information obtained through the control frame exchange (e.g., ICF/ICR frame exchange) performed during the polling phase.

For the sharing AP to make efficient decisions regarding c-TDMA, it should be able to obtain relevant information during the polling phase. Also, a mechanism for selecting the final shared AP(s) based on the obtained information is needed. The present disclosure describes the decision criteria that can be used by the sharing AP to determine whether or not to perform c-TDMA and how to select the shared AP(s) that are to participate in the c-TDMA (if the sharing AP decides to perform c-TDMA).

The sharing AP may determine the shared AP(s) to share its TXOP with based on information obtained during the polling phase. For example, the sharing AP may decide to share a portion of its TXOP with candidate shared AP(s) that possess low-latency traffic or traffic associated with a particular AC. If low-latency traffic is mapped to a specific AC, the candidate shared AP(s) that possess traffic associated with that specific AC may be selected to be the final shared AP(s). The sharing AP may then sequentially transmit TXOP sharing frames to the selected candidate shared AP(s) to share the TXOP with those shared AP(s). The selected candidate shared AP(s) thus become the final shared AP(s) for c-TDMA.

In this scenario, the shared AP(s) may implicitly understand that the TXOP being shared by the sharing AP as part of the c-TDMA process is intended for processing certain categories of traffic such as low-latency traffic or traffic associated with a specific AC. For example, it can be agreed/understood in advance that the purpose of the control frame exchange (e.g., ICF/ICR frame exchange) during the polling phase is to exchange information regarding traffic associated with a specific AC. Accordingly, the candidate shared AP may process traffic associated with that specific AC during its allocated portion of the TXOP.

There may be cases where the shared AP completes processing low-latency traffic or traffic associated with the specific AC before its allocated portion of the TXOP expires. For example, this could occur due to the shared AP having better than expected channel conditions, resulting in fewer retransmissions.

In such cases, there is a need to define how to handle/use the time remaining in the . allocated portion of the TXOP. If the behavior in this situation is not defined, the time remaining in the TXOP could return to a contention free state where all STAs can compete for access. This would mean that the original TXOP owner (i.e., the sharing AP) would lose its transmission rights. Furthermore, if the sharing AP had plans to share portions of its TXOP with additional shared AP(s), it would not be possible to proceed with allocating the next portion of the TXOP to the next shared AP.

The present disclosure describes a mechanism to handle the situation where the shared AP completes processing traffic associated with a specific AC before its allocated portion of the TXOP has expired and thus there is still time remaining in its allocated portion of the TXOP.

In an embodiment, through the control frame exchange (e.g., ICF/ICR frame exchange) during the polling phase, the sharing AP may determine which candidate shared AP(s) possess traffic associated with an AC that corresponds to low-latency traffic, and the shared AP may select these candidate shared AP(s) to be the final shared AP(s).

In an embodiment, the ICF/ICR can be designed as follows to inquire about the presence of low-latency traffic at the candidate shared AP(s). The initial control frame may include a field for indicating an AC. Only candidate shared AP(s) that have traffic associated with the AC indicated in this field may be allowed to respond to the initial control frame with an initial control response frame. For example, consider the situation where the AC corresponding to low-latency traffic is AC_VO (voice access category). For purposes of explanation only, it is assumed in this description that AC_VO corresponds to low-latency traffic. This AC_VO could be the same as the existing AC_VO defined in the IEEE 802.11 wireless networking standards or differ only in TID. It should be appreciated, however, that low latency traffic can correspond to a different AC or be identified in other ways. AC_BK (background access category), AC_BE (best effort access category), AC_VI (video access category), and AC_VO can have values of 0, 1, 2, and 3, respectively. As an example, if the field for indicating AC in the initial control frame indicates AC_VO (e.g., value=3), the candidate shared AP may respond with an initial control response frame that indicates that the candidate shared AP possesses traffic associated with AC_VO. In an embodiment, the initial control response frame includes information regarding the characteristics of the traffic such as the amount of AC_VO traffic that the candidate shared AP possesses and/or the traffic arrival time of periodic AC_VO traffic that is expected to occur in the future even if the traffic is not currently present in the queue. In some cases, the candidate shared AP might not possess traffic associated with AC_VO (e.g., there is no AC_VO traffic in its queue and there is no periodic AC_VO traffic that is expected to occur in the near future). In such cases, the candidate shared AP may choose not to respond to the polling from the sharing AP. Alternatively, the candidate shared AP may inform the sharing AP regarding the highest AC (highest priority traffic) that the candidate shared AP possesses. As used herein, the term “possesses traffic” or similar phraseology may refer to having immediate traffic to transmit/receive (e.g., in a queue/buffer) or having particular traffic that is expected to occur in the future (e.g., periodic low-latency traffic).

In an embodiment, the initial control frame includes a field for indicating the low-latency traffic reporting mode. The field being set to a value of “0” may mean “respond if there is low-latency traffic or share information about other traffic if there is no low-latency traffic.” If the value of the field in the initial control frame is set to “0” and the candidate shared AP possesses low-latency traffic, the candidate shared AP may transmit an initial control response frame that includes information regarding the characteristics of the low-latency traffic such as the amount of low-latency traffic (e.g., traffic associated with AC_VO) in the queue and/or the arrival time of periodic low-latency traffic that is expected to occur soon. However, it is possible that the shared AP does not possess low-latency traffic. If the candidate shared AP does not possess low-latency traffic, the candidate shared AP may transmit an initial control response frame that includes an indication of the highest priority traffic (e.g., highest AC) that the candidate shared AP possesses.

The field in the initial control frame (for indicating the low-latency traffic reporting mode) being set to a value of “1” may mean “respond only with information regarding low-latency traffic.” If the value of the field in the initial control frame is set to “1” and the candidate shared AP possesses low-latency traffic, the candidate shared AP may may transmit an initial control response frame that includes information regarding the characteristics of the low-latency traffic such as the amount of low-latency traffic (e.g., traffic associated with AC_VO) in the queue and/or the arrival time of periodic low-latency traffic that is expected to occur soon. If the shared AP does not possess low-latency traffic, the shared AP may refrain from responding to the initial control frame. This low-latency traffic reporting mode may be useful when the sharing AP has a large volume of low-latency traffic demands to handle. Stated differently, this mode may be useful when there are resource shortages, and thus TXOP sharing will only be considered for processing low-latency traffic.

The sharing AP may determine which candidate shared AP(s), if any, will become the final shared AP(s) based on information obtained through a control frame exchange during the polling phase. For example, the sharing AP may prioritize selecting candidate shared AP(s) that possess AC_VO traffic (has AC_VO traffic currently in the queue or is expected to have AC_VO traffic in the near future). As another example, the sharing AP may prioritize selecting candidate shared AP(s) possess the largest amount of AC_VO traffic if there is more than one candidate shared AP that possesses AC_VO traffic. As another example, the sharing AP may determine the order of sequential TXOP sharing based on the arrival times of periodic AC_VO traffic or other timing factors. More generally, the sharing AP may determine which candidate shared AP(s), if any, should become the final shared AP(s) based on a combination of various factors/information such as the presence of AC_VO traffic, the amount of AC_VO traffic, the amount of future periodic AC_VO traffic, traffic arrival times, and/or other traffic characteristics. The sharing AP may compare the characteristics of the candidate shared AP(s)'s traffic to the characteristics of the sharing AP's own traffic to determine whether it would be better for the sharing AP to transmit its own traffic instead of sharing its TXOP with the candidate shared AP(s). This means that the sharing AP does not necessarily have to share its TXOP with candidate shared AP(s) even if the candidate shared AP(s) possess AC_VO traffic. Instead, the sharing AP may consider its own AC_VO traffic and other AC traffic when deciding whether to share its TXOP. If the sharing AP does decide to share its TXOP (i.e., decides to perform c-TDMA), the sharing AP may determine which candidate shared AP(s) to share the TXOP with based on information (e.g., buffer status per AC, stream classification service (SCS) information, etc.) provided by the candidate shared AP(s) during the polling phase.

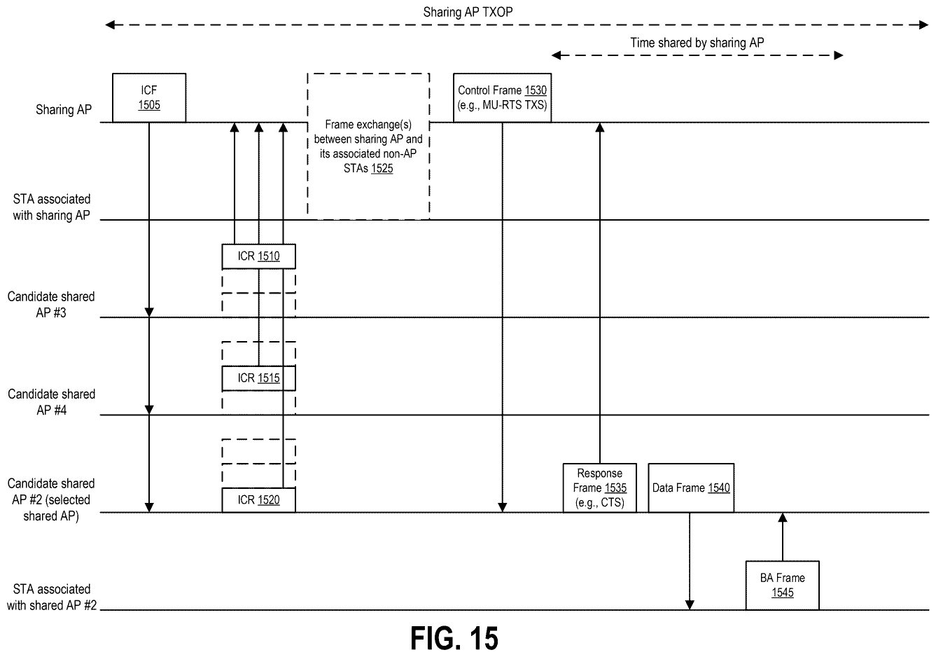

FIG. 15 is a diagram showing a frame exchange sequence for c-TDMA, according to some embodiments.

As shown in the diagram, the sharing AP may transmit initial control frame (ICF) 1505 to candidate shared APs including candidate shared AP #2, candidate shared AP #3, and candidate shared AP #4 to poll these candidate shared APs regarding participation in c-TDMA. Initial control frame 1505 may include an indication of a primary traffic priority level (e.g., a specific AC) of traffic to be transmitted during the c-TDMA.

Each of the candidate shared APs that receive initial control frame 1505 may transmit an initial control response frame (ICR) to the sharing AP if they possess traffic having the primary traffic priority level indicated in the initial control frame 1505 or a higher traffic priority level. In the example shown in the diagram, it is assumed that candidate shared AP #2, candidate shared AP #3, and candidate shared AP #4 possess traffic having the primary traffic priority level indicated in initial control frame 1505 or a higher traffic priority level. Thus, candidate shared AP #2 may transmit initial control frame 1520 to the sharing AP, candidate shared AP #3 may transmit initial control frame 1510 to the sharing AP, and candidate shared AP #4 may transmit initial control frame 1515 to the sharing AP. In an embodiment, as shown in the diagram, the candidate shared APs transmit their respective initial control response frames to the sharing AP simultaneously (in different frequency resources). The sharing AP may select one or more of the candidate shared APs that responded to be the final shared AP(s) based on information included in the received initial control response frames. In this example, it is assumed that the sharing AP selects candidate shared AP #2 to be the final shared AP.

Before sharing its TXOP with candidate shared AP #2, the sharing AP may perform frame exchange(s) 1525 with its associated non-AP STA(s). After the sharing AP finishes performing frame exchange(s) 1525, the sharing AP may transmit control frame 1530 to candidate shared AP #2 (since it is the selected candidate shared AP in this example) to share a portion of the sharing AP's TXOP with candidate shared AP #2. Responsive to receiving control frame 1530, candidate shared AP #2 may transmit response frame 1535 to the sharing AP. In an embodiment, control frame 1530 is a MU-RTS TXS frame and response frame 1535 is a CTS frame. During the portion of the sharing AP's TXOP allocated to candidate shared AP #2 (depicted as “Time shared by sharing AP” in the diagram), the shared AP may transmit data frame 1540 to a STA that is associated with candidate shared AP #2. If the STA successfully receives data frame 1540, the STA may transmit BA frame 1545 to candidate shared AP #2.

As mentioned above, during a polling phase of c-TDMA, candidate shared APs may provide traffic characteristics information to the sharing AP regarding low-latency traffic that they possess (e.g., through a ICF/ICR frame exchange). The sharing AP may select a candidate shared AP to be a final shared AP based on the traffic characteristics information (e.g., amount of AC_VO traffic) provided by the candidate shared APs. The sharing AP may then transmit a MU-RTS TXS frame to the selected candidate shared AP to share a portion of the sharing AP's TXOP with the selected candidate shared AP, and the candidate shared AP may respond by transmitting a CTS frame. The selected candidate shared AP becomes the final shared AP.

The shared AP may prioritize processing AC_VO traffic during the portion of the TXOP allocated to the shared AP (e.g., during the duration indicated in the MU-RTS TXS frame). This behavior assumes that the sharing AP explicitly or implicitly instructed the shared AP to prioritize AC_VO traffic during the allocated TXOP. However, the shared AP might finish its transmission and/or reception of AC_VO traffic early, before the allocated portion of the TXOP expires. In this case, it is important to effectively manage the remaining time in the allocated portion of the TXOP.

In an embodiment, the shared AP can handle such a situation differently depending on whether the sharing AP requests a TXOP or does not request a TXOP return.

When the sharing AP requests a TXOP return, the shared AP may transmit a TXOP return frame to the sharing AP to return the TXOP to the sharing AP after processing all of its AC_VO traffic. However, if there is no rule specifying that TXOP should be returned immediately after processing AC_VO traffic, the shared AP may use the remaining time in its allocated portion of the TXOP (the time remaining after processing AC_VO traffic) to process other traffic (e.g., AC_BE traffic) and then return the TXOP to the sharing AP before its allocated portion of the TXOP expires. If there is an opportunity to use the remaining time in its allocated portion of the TXOP before transmitting the TXOP return frame, the shared AP may perform the following: after processing AC_VO traffic, the shared AP may sequentially process other traffic having lower traffic priority level in order of priority. This aligns with the existing rule in Wi-Fi that when a channel is occupied using enhanced distributed channel access (EDCA), after servicing traffic associated with a particular AC that was used for channel occupancy, traffic associated with other ACs can be serviced. Since the TXOP shared by the sharing AP is primarily for processing AC_VO traffic, once AC_VO traffic has been processed, there is no issue with servicing traffic associated with other ACs during the remaining time before transmitting the TXOP return frame. This allows the shared AP to make effective use of the time remaining in its allocated portion of the TXOP.

When the sharing AP does not request a TXOP return, the shared AP may have more autonomy compared to the case when the sharing AP requests a TXOP return. For example, after finishing transmission and/or reception of AC_VO traffic, the shared AP may process traffic associated with other ACs during the time remaining in the portion of the TXOP allocated to the shared AP.

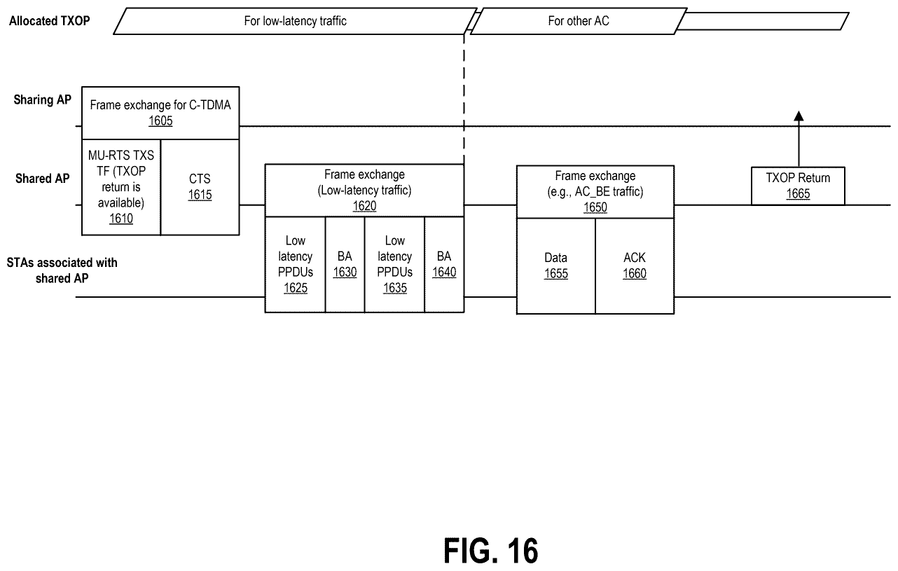

FIG. 16 is a diagram showing how a shared AP can use the time remaining in its allocated portion of the TXOP in a c-TDMA scenario where TXOP return is allowed, according to some embodiments.

As shown in the diagram, the sharing AP and the shared AP may perform frame exchange for c-TDMA 1605, which may include a frame exchange of MU-RTS TXS trigger frame (TF) 1610 and CTS frame 1615. MU-RTS TXS trigger frame 1610 may include an indication that TXOP return is allowed.

The shared AP and its associated non-AP STAs may perform frame exchange 1620, which may include a PPDU/frame exchange of low-latency PPDUs 1625, BA frame 1630, low-latency PPDUs 1635, and BA frame 1640. After the shared AP finishes transmitting and/or receiving low-latency traffic (traffic associated with AC_VO in this example), the shared AP may transmit traffic associated with other ACs. For example, the shared AP and its associated non-AP STAs may perform frame exchange 1650, which may include a frame exchange of data frame 1655 (e.g., including AC_BE data) and acknowledgement (ACK) frame 1660. After the shared AP completes transmitting and/or receiving the traffic associated with other ACs, the shared AP may transmit TXOP return frame 1665 to the sharing AP to return the TXOP to the sharing AP. The sharing AP may then resume the TXOP. Thus, after finishing transmission and reception of low-latency traffic early, the shared AP may use the time remaining in its allocated portion of the TXOP to transmit non-low-latency traffic before returning the TXOP to the sharing AP.

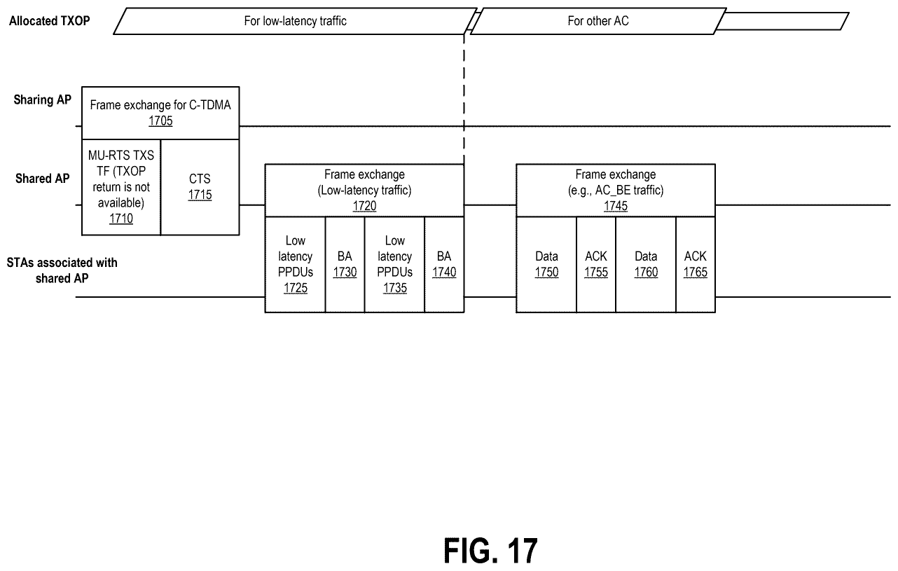

FIG. 17 is a diagram showing how a shared AP can use the time remaining in its allocated portion of the TXOP in a c-TDMA scenario where TXOP return is not allowed, according to some embodiments.

As shown in the diagram, the sharing AP and the shared AP may perform frame exchange for c-TDMA 1705, which may include a frame exchange of MU-RTS TXS trigger frame (TF) 1710 and CTS frame 1715. MU-RTS TXS trigger frame 1710 may include an indication that TXOP return is not allowed.

The shared AP and its associated non-AP STAs may perform frame exchange 1720, which may include a PPDU/frame exchange of low-latency PPDUs 1725, BA frame 1730, low-latency PPDUs 1735, and BA frame 1740. After the shared AP completes transmitting and/or receiving low-latency traffic (traffic associated with AC_VO in this example), the shared AP may transmit traffic associated with other ACs until the shared AP's allocated portion of the TXOP expires. For example, the shared AP and its associated non-AP STAs may perform frame exchange 1745 for AC_BE traffic, which may include a frame exchange of data frame 1750 (including AC_BE data), ACK frame 1755, data frame 1760 (including AC_BE data), and ACK frame 1765. Thus, after finishing transmission and reception of low-latency traffic, the shared AP may use the time remaining in its allocated portion of the TXOP to transmit non-low-latency traffic.

The present disclosure describes a mechanism for the sharing AP to poll candidate shared APs regarding their interest in participating in c-TDMA. Through a frame exchange during a polling phase, the sharing AP may obtain information regarding the presence and characteristics of traffic that candidate shared APs possess and make an informed decision regarding whether to perform c-TDMA (i.e., determine whether to share its TXOP with a candidate shared AP) and which candidate shared AP(s) should be the final shared AP(s) for TXOP sharing. Also, the present disclosure describes how a shared AP that has been allocated a portion of a sharing AP's TXOP can effectively utilize any time remaining in its allocated portion of the sharing AP's TXOP when the shared AP finishes processing low-latency traffic before its allocated portion of the TXOP expires.

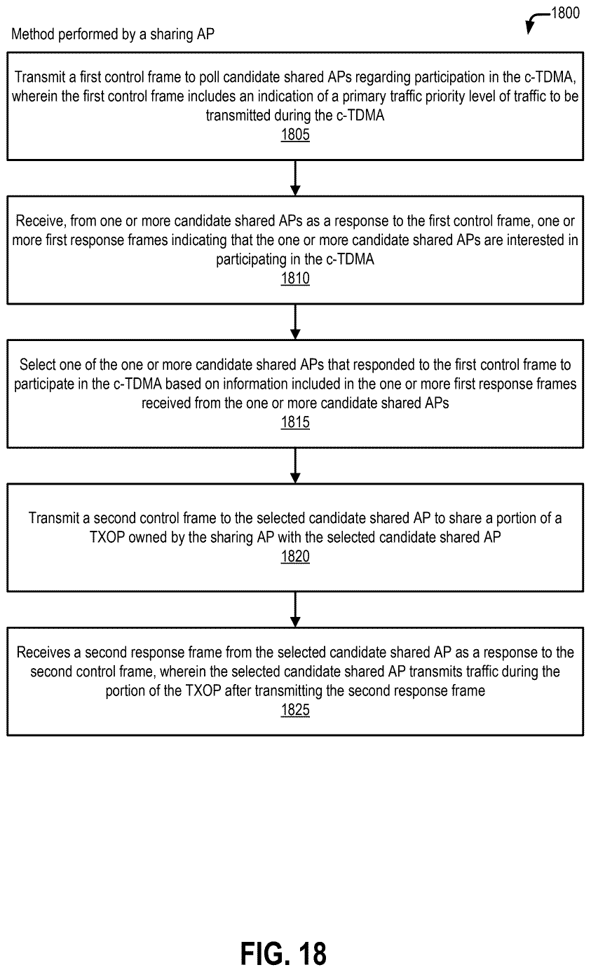

Turning now to FIG. 18, a method 1800 will be described for polling candidate shared APs regarding participation in c-TDMA, in accordance with an example embodiment. The method 1800 may be performed by a sharing AP. The sharing AP may implemented by a wireless device (e.g., wireless device 104).

Additionally, although shown in a particular order, in some embodiments the operations of the method 1800 (and the other methods shown in the other figures) may be performed in a different order. For example, although the operations of the method 1800 are shown in a sequential order, some of the operations may be performed in partially or entirely overlapping time periods.

At operation 1805, the sharing AP transmits a first control frame to poll candidate shared APs regarding participation in the c-TDMA, wherein the first control frame includes an indication of a primary traffic priority level of traffic to be transmitted during the c-TDMA. In an embodiment, the primary traffic priority level is indicated in the first control frame as an AC (access category). In an embodiment, the AC is any one of: a background access category, a best effort access category, a video access category, and a voice access category.

At operation 1810, the sharing AP receives, from one or more candidate shared APs as a response to the first control frame, one or more first response frames indicating that the one or more candidate shared APs are interested in participating in the c-TDMA.

At operation 1815, the sharing AP selects one of the one or more candidate shared APs that responded to the first control frame to participate in the c-TDMA based on information included in the one or more first response frames received from the one or more candidate shared APs.

In an embodiment, the first response frame received from the selected candidate shared AP includes an indication that the selected candidate shared AP possesses traffic to transmit that has the primary traffic priority level indicated in the first control frame or a higher traffic priority level. In an embodiment, the first response frame received from the selected candidate shared AP further includes information regarding characteristics of traffic possessed by the selected candidate shared AP. In an embodiment, the information regarding characteristics of traffic possessed by the selected candidate shared AP includes one or more of: information regarding a traffic amount and information regarding a traffic timing.

In an embodiment, the first response frame received from a second one of the one or more candidate shared APs other than the selected candidate shared AP includes an indication of a highest traffic priority level of traffic possessed by the second candidate shared AP because the second candidate shared AP does not possess traffic having the primary traffic priority level indicated in the first control frame or a higher traffic priority level.

At operation 1820, the sharing AP transmits a second control frame to the selected candidate shared AP to share a portion of a TXOP owned by the sharing AP with the selected candidate shared AP.

In an embodiment, at operation 1825, the sharing AP receives a second response frame from the selected candidate shared AP as a response to the second control frame, wherein the selected candidate shared AP transmits traffic during the portion of the TXOP after transmitting the second response frame.

In an embodiment, the sharing AP selects a second one of the one or more candidate shared APs that responded to the first control frame to participate in the c-TDMA based on information included in the one or more first response frames received from the one or more candidate shared APs. The sharing AP may then transmit a third control frame to the second selected candidate shared AP to share a second portion of the TXOP with the second selected candidate shared AP. The sharing AP may then receive a third response frame from the second selected candidate shared AP as a response to the third control frame, wherein the second selected candidate shared AP transmits traffic during the second portion of the TXOP after transmitting the third response frame.

In an embodiment, the first control frame is an initial control frame. In an embodiment, the one or more first response frames are one or more initial control response frames. In an embodiment, the one or more first response frames comprise at least two first response frames that are received simultaneously from at least two candidate shared APs. In an embodiment, the second control frame is a TXOP sharing frame. In an embodiment, the second response frame is a CTS frame.

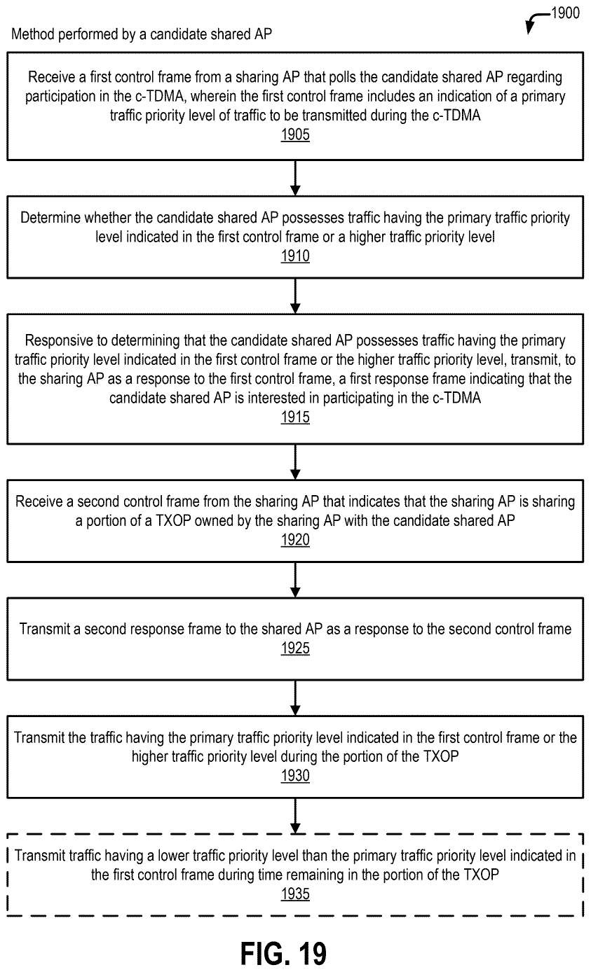

Turning now to FIG. 19, a method 1900 will be described for participating in c-TDMA, in accordance with an example embodiment. The method 1900 may be performed by a candidate shared AP. The candidate shared AP may implemented by a wireless device (e.g., wireless device 104).

At operation 1905, the candidate shared AP receives a first control frame from a sharing AP that polls the candidate shared AP regarding participation in the c-TDMA, wherein the first control frame includes an indication of a primary traffic priority level of traffic to be transmitted during the c-TDMA. In an embodiment, the primary traffic priority level is indicated in the first control frame as an AC (access category). In an embodiment, the AC is any one of: a background access category, a best effort access category, a video access category, and a voice access category.

At operation 1910, the candidate shared AP determines whether the candidate shared AP possesses traffic having the primary traffic priority level indicated in the first control frame or a higher traffic priority level.

At operation 1915, responsive to determining that the candidate shared AP possesses traffic having the primary traffic priority level indicated in the first control frame or the higher traffic priority level, the candidate shared AP transmits, to the sharing AP as a response to the first control frame, a first response frame indicating that the candidate shared AP is interested in participating in the c-TDMA. In an embodiment, the first response frame includes an (explicit) indication that the candidate shared AP possesses traffic that has the primary traffic priority level indicated in the first control frame or the higher traffic priority level. In an embodiment, the first response frame further includes information regarding characteristics of traffic possessed by the candidate shared AP. In an embodiment, the information regarding characteristics of traffic possessed by the candidate shared AP includes one or more of: information regarding a traffic amount and information regarding traffic timing. In an embodiment, if the candidate shared AP does not possess traffic having the primary traffic priority level indicated in the first control frame or the higher traffic priority level, the candidate shared AP is allowed to include an indication of a highest traffic priority level of traffic possessed by the candidate shared AP in the first response frame. In an embodiment, the first response frame is transmitted simultaneously with one or more other response frames transmitted by one or more other candidate shared APs.

At operation 1920, the candidate shared AP receives a second control frame from the sharing AP that indicates that the sharing AP is sharing a portion of a TXOP owned by the sharing AP with the candidate shared AP (and thus the candidate sharing AP becomes the final shared AP).

At operation 1925, the candidate shared AP transmits a second response frame to the shared AP as a response to the second control frame.

At operation 1930, the candidate shared AP transmits the traffic having the primary traffic priority level indicated in the first control frame or the higher traffic priority level during the portion of the TXOP.

In an embodiment, at operation 1935, the candidate shared AP transmits traffic having a lower traffic priority level than the primary traffic priority level indicated in the first control frame during time remaining in the portion of the TXOP.

In an embodiment, the first control frame is an initial control frame. In an embodiment, the first response frame is an initial control response frame. In an embodiment, the second control frame is a TXOP sharing frame. In an embodiment, the second response frame is a CTS frame.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a sharing access point (AP) to poll candidate shared APs regarding participation in coordinated time division multiple access (c-TDMA), the method comprising:
transmitting a first control frame to poll candidate shared APs regarding participation in the c-TDMA, wherein the first control frame includes an indication of a primary traffic priority level of traffic to be transmitted during the c-TDMA;
receiving, from one or more candidate shared APs as a response to the first control frame, one or more first response frames indicating that the one or more candidate shared APs are interested in participating in the c-TDMA;
selecting one of the one or more candidate shared APs that responded to the first control frame to participate in the c-TDMA based on information included in the one or more first response frames received from the one or more candidate shared APs;
transmitting a second control frame to the selected candidate shared AP to share a portion of a transmission opportunity (TXOP) owned by the sharing AP with the selected candidate shared AP; and
receiving, a second response frame from the selected candidate shared AP as a response to the second control frame, wherein the selected candidate shared AP transmits traffic during the portion of the TXOP after transmitting the second response frame.

2. The method of claim 1, wherein the primary traffic priority level is indicated in the first control frame as an access category (AC).

3. The method of claim 2, wherein the AC is any one of: a background access category, a best effort access category, a video access category, and a voice access category.

4. The method of claim 1, wherein the first response frame received from the selected candidate shared AP includes an indication that the selected candidate shared AP possesses traffic that has the primary traffic priority level indicated in the first control frame or a higher traffic priority level.

5. The method of claim 1, wherein the first response frame received from the selected candidate shared AP further includes information regarding characteristics of traffic possessed by the selected candidate shared AP.

6. The method of claim 4, wherein the information regarding characteristics of traffic possessed by the selected candidate shared AP has to transmit includes one or more of: information regarding a traffic amount and information regarding a traffic timing.

7. The method of claim 1, wherein the first response frame received from a second one of the one or more candidate shared APs other than the selected candidate shared AP includes an indication of a highest traffic priority level of traffic possessed by the second candidate shared AP because the second candidate shared AP does not possess traffic having the primary traffic priority level indicated in the first control frame or a higher traffic priority level.

8. The method of claim 1, further comprising:
selecting a second one of the one or more candidate shared APs that responded to the first control frame to participate in the c-TDMA based on information included in the one or more first response frames received from the one or more candidate shared APs;
transmitting a third control frame to the second selected candidate shared AP to share a second portion of the TXOP with the second selected candidate shared AP; and
receiving a third response frame from the second selected candidate shared AP as a response to the third control frame, wherein the second selected candidate shared AP transmits traffic during the second portion of the TXOP after transmitting the third response frame.

9. The method of claim 1, wherein the first control frame is an initial control frame.

10. The method of claim 9, wherein the one or more first response frames are one or more initial control response frames.

11. The method of claim 10, wherein the one or more first response frames comprise at least two first response frames that are received simultaneously from at least two candidate shared APs.

12. The method of claim 1, wherein the second control frame is a TXOP sharing frame.

13. The method of claim 12, wherein the second response frame is a clear-to-send (CTS) frame.

14. A method performed by a candidate shared access point (AP) to participate in coordinated time division multiple access (c-TDMA), the method comprising:
receiving a first control frame from a sharing AP that polls the candidate shared AP regarding participation in the c-TDMA, wherein the first control frame includes an indication of a primary traffic priority level of traffic to be transmitted during the c-TDMA;
determining whether the candidate shared AP possesses traffic having the primary traffic priority level indicated in the first control frame or a higher traffic priority level;
responsive to determining that the candidate shared AP possesses traffic having the primary traffic priority level indicated in the first control frame or the higher traffic priority level, transmitting, to the sharing AP as a response to the first control frame, a first response frame indicating that the candidate shared AP is interested in participating in the c-TDMA;
receiving a second control frame from the sharing AP that indicates that the sharing AP is sharing a portion of a transmission opportunity (TXOP) owned by the sharing AP with the candidate shared AP;
transmitting a second response frame to the shared AP as a response to the second control frame; and
transmitting the traffic having the primary traffic priority level indicated in the first control frame or the higher traffic priority level during the portion of the TXOP.

15. The method of claim 14, wherein the primary traffic priority level is indicated in the first control frame as an access category (AC).

16. The method of claim 15, wherein the AC is any one of: a background access category, a best effort access category, a video access category, and a voice access category.

17. The method of claim 14, wherein the first response frame includes an indication that the candidate shared AP possesses traffic that has the primary traffic priority level indicated in the first control frame or the higher traffic priority level.

18. The method of claim 17, wherein the first response frame further includes information regarding characteristics of traffic possessed by the candidate shared AP.

19. The method of claim 18, wherein the information regarding characteristics of traffic possessed by the candidate shared AP includes one or more of: information regarding a traffic amount and information regarding traffic timing.

20. The method of claim 14, wherein if the candidate shared AP does not possess traffic having the primary traffic priority level indicated in the first control frame or the higher traffic priority level, the candidate shared AP is allowed to include an indication of a highest traffic priority level of traffic possessed by the candidate shared AP in the first response frame.

21. The method of claim 14, wherein the first control frame is an initial control frame.

22. The method of claim 21, wherein the first response frame is an initial control response frame.

23. The method of claim 14, wherein the first response frame is transmitted simultaneously with one or more other response frames transmitted by one or more other candidate shared APs.

24. The method of claim 14, wherein the second control frame is a TXOP sharing frame.

25. The method of claim 24, wherein the second response frame is a clear-to-send (CTS) frame.
